(19) United States
(12) Patent Application Publication
(10) Pub. No.: US 2025/0391221 A1
(43) Pub. Date: Dec. 25, 2025

(54) VENDOR-AGNOSTIC POS DISPLAY CAPTURE, ORDER NORMALIZATION, AND AUTOMATED BEVERAGE PREPARATION SYSTEM

(71) Applicants: Soykan DIRIK, Laguna Niguel, CA (US); Mehmet KAPTANA, Irvine, CA (US)

(72) Inventors: Soykan DIRIK, Laguna Niguel, CA (US); Mehmet KAPTANA, Irvine, CA (US)

(21) Appl. No.: 19/304,657

(22) Filed: Aug. 20, 2025

Related U.S. Application Data
(63) Continuation-in-part of application No. 18/223,099, filed on Jul. 18, 2023.

(51) Int. Cl. G07F 9/00; G06F 9/445; G06F 40/205; G06Q 20/20; G06V 30/10; H04L 9/40

(52) U.S. Cl. CPC G07F 9/006; G06F 9/44505; G06F 40/205; G06Q 20/20; G06V 30/10; H04L 63/0428

(57) ABSTRACT

A vendor-agnostic system captures rendered point-of-sale (POS) display output without requiring POS API integration, applies optical character recognition (OCR) and parsing to extract beverage order information, normalizes the order into a canonical recipe, and generates device-specific control commands for smart beverage-making equipment. The system includes calibration for store-specific layouts, confidence-scored extraction with operator confirmation, and a device capability profile library for heterogeneous protocols, enabling automated preparation across diverse machines.

### CROSS-REFERENCE TO RELATED APPLICATION

This application is a continuation-in-part application of non-provisional application Ser. No. 18/223,099, filed on Jul. 18, 2023, the entire content of which is incorporated herein by reference.

### TECHNICAL FIELD

The invention relates to interoperability between point-of-sale (POS) systems and automated food and beverage equipment. More particularly, it concerns systems and methods for capturing POS-rendered order content, performing OCR and parsing, normalizing orders, and orchestrating heterogeneous beverage preparation devices.

### BACKGROUND

In restaurants, cafes, and other food service environments, customer orders are typically entered into POS systems and then manually transcribed or verbally relayed to staff who prepare beverages or food items. This process is time-consuming, prone to human error, and limits throughput and scalability.

Existing retail beverage environments rely on POS systems from many vendors with divergent user interfaces and data models. Integrating each new beverage device with each POS often requires custom Application Programming Interfaces (APIs), certifications, or printer-port workarounds, creating cost, brittleness, and vendor lock-in.

To be more specific, FIG. 1 illustrates a conventional deployment that a staff prepares a drink based on output of a merchant POS station. The typical operations are as follow: (1) customer places order at the drive-thru kiosk, (2) order details are transmitted to the POS system, (3) the crew reads the order on the KDS/slip, including customizations such as “size”, “add-on flavors”, and “ice level”, (4) the crew prepares the drink order based on the specified details, and (5) the prepared beverages are verified and handed to the customer at the drive-thru window.

FIG. 2 illustrates a conventional POS station with smart equipment through bespoke, vendor-specific integrations. In this process, a POS may require a proprietary software driver, middleware plug-in, or certified gateway that translates POS order data into device commands for a single downstream machine. Each pairing of the POS with the downstream machine typically requires per-vendor engineering, certification, and ongoing maintenance, and updates to either side (software versions, data schemas, security changes) can break compatibility. Multi-vendor sites therefore accumulate parallel integrations that are costly to deploy and fragile to maintain.

In a typical kitchen-display-system (KDS) workflow, as shown in FIG. 3, the POS renders orders on a KDS panel for a human operator to read and act upon. Items, sizes, and modifiers are presented visually but are not provided to equipment in a machine-readable, normalized form. Throughput and quality depend on operator attention; UI abbreviations vary by store; and transcription mistakes (e.g., “no ice” vs. “light ice”) can lead to errors and remakes. Adding or upgrading automated equipment does not benefit from the KDS output because there is no device-level orchestration.

FIG. 3 further shows that some merchants rely on printer-based flows in which the POS produces receipts or labels that staff carry to preparation stations. This paper channel can be reliable for humans but is not directly consumable by machines without additional processing. Print quality (thermal fade, smudge), formatting differences across templates, and reprints for order changes complicate automation. Optional barcodes or QR codes may appear on some receipts, but they are not standard across vendors or sites and often omit modifier semantics required by preparation equipment.

A frequently proposed solution is a one-off API connection between a specific POS and a specific device. While effective in a controlled pairing, this approach scales poorly across the hundreds of POS variants in the market and across mixed-equipment back rooms. FIG. 4 illustrates examples of the variety of different order structures displayed in the existing POS systems. Version drift, deprecations, rate limits, authentication policies, and certification programs introduce ongoing overhead; each new vendor or model typically demands a fresh integration project. As a result, merchants face integration lock-in and delayed rollouts whenever they change POS software, add devices, or expand locations.

Therefore, there is a need for a vendor-agnostic bridge that operates on whatever the POS renders on screen, extracting the same semantics a human operator would read and driving one or more beverage devices accordingly, without requiring cooperation from, or modifications to, the POS.

### SUMMARY

Disclosed is a system (“POSBOX”) that ingests rendered POS display content via electronic screen mirroring, operating system (OS)-level screen capture, or camera-based capture; applies Optical Character Recognition (OCR) and parsing to identify items and modifiers; normalizes output into a canonical recipe representation; and emits device-specific commands to beverage preparation equipment.

The system comprises:
A camera or image capture module aimed at or connected to the POS display to capture image from the POS display.
An OCR processor configured to extract text from the captured image.
A parsing module to extract structured order data (e.g., drink type, size, modifiers) from different POS layouts and menu structures.
A communication interface to transmit structured data to automated drink-making equipment.
An optional learning module to improve recognition and interpretation across different POS formats.

The system allows seamless integration into any POS environment without requiring changes to existing software, providing a drop-in solution for automation.

The system supports interchangeable ingestion modes including API, webhook, and High-Definition Multimedia Interface (HDMI)/Kitchen Display System (KDS) capture, and provides a configuration and test Graphical User Interface (GUI) that enables rapid site setup, offline image simulation, real-time HDMI capture, and JavaScript Object Notation (JSON) configuration generation.

### BRIEF DESCRIPTION OF THE DRAWINGS

FIG. 1 illustrates a conventional deployment that a staff prepares a drink based on output of a merchant POS station.

FIG. 2 illustrates a conventional POS station with smart equipment through bespoke, vendor-specific integrations.

FIG. 3 depicts a merchant environment using a KDS display panel or a printer to convey order information to staff.

FIG. 4 illustrates examples of the variety of different order structures displayed in the existing POS systems.

FIG. 5 is a system-level view in which a POS terminal provides output to a POS Box of the instant disclosure, in which controls smart equipment including a beverage dispenser and an automated food/beverage device.

FIG. 6 is a hardware block diagram of a POS box of the instant disclosure.

FIG. 7 is a block diagram of the POS box showing the processes of the POS box.

FIG. 8 shows API mode where a POS system (202) exposes an API (204) polled by POSBOX (206).

FIG. 9 shows Webhook mode where the POS system (202) pushes events to a webhook endpoint (230) consumed by POSBOX (206).

FIG. 10 shows HDMI/KDS capture mode where a KDS/display (222) provides a video signal via HDMI/capture (224) into POSBOX (206).

FIG. 11 shows representative inputs to the POS Box (100), including a POS terminal (220) and a KDS system box (222) connected through USB-C/HDMI capture (224).

FIG. 12 shows a printer-output ingestion embodiment where a POS terminal (220) prints to one or more printers (306) whose content is rendered and processed by the POS Box (100).

FIG. 13 shows a direct connection from a POS terminal (220) through an interface (224) to the POS Box (100), which issues commands to a Freestyle® beverage dispenser (162).

FIG. 14 shows a deployment including a POS terminal (220), a KDS terminal (222), an HDMI interface (224) to the POS Box (100), and a downstream AFS-class device (164).

FIGS. 15-28 illustrate screenshots of the POSBOX Config Generator and Test GUI.

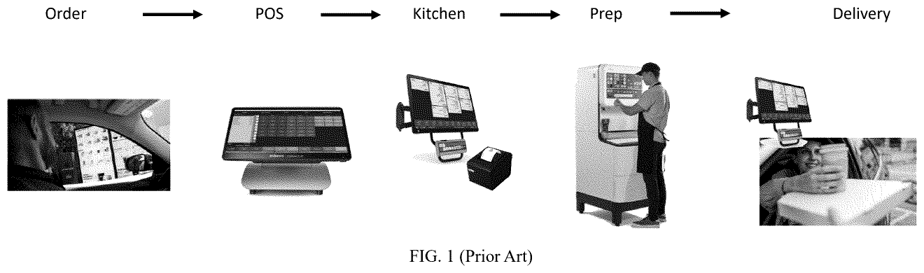

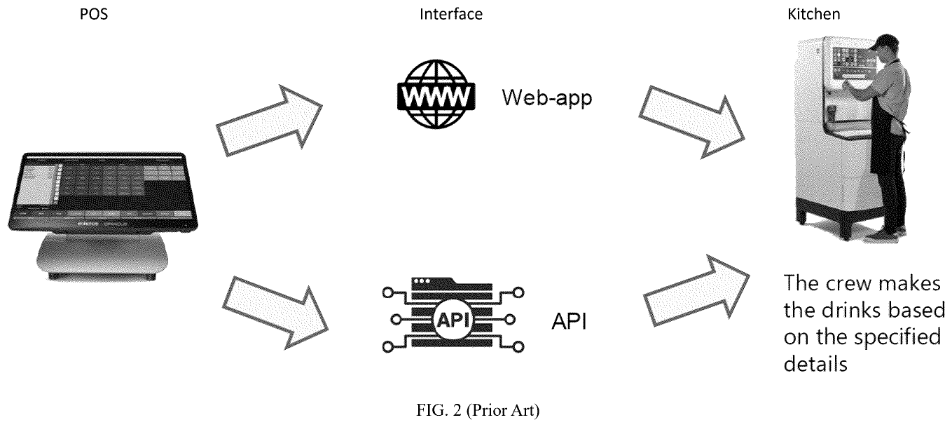

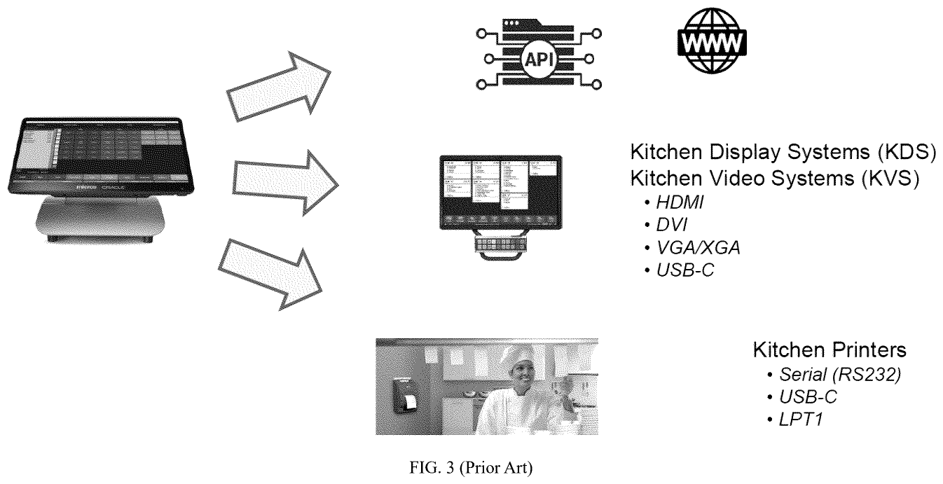

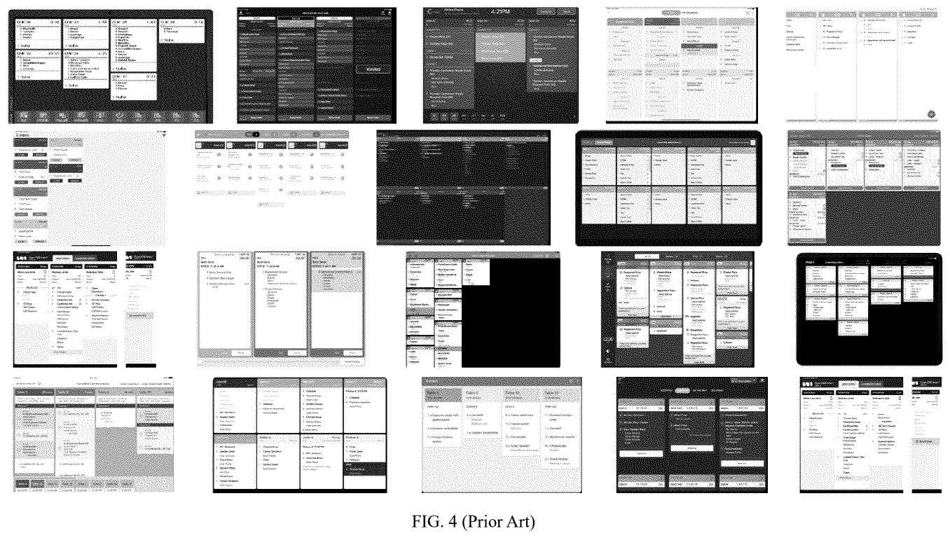

### REFERENCE NUMERALS

100 POSBOX/Pos Box
101 Processor
102 Memory
103 Analog video input ports
104 Digital video input ports
105 Wireless transceiver
106 Network interface
111 Analog Video Input
112 Digital Video Input
113 WIFI Screen Mirror
120 POSBOX Core Service Software
122 Screen Frame Capture
124 IMAGE PROCESS: Various mathematical operations on the image
126 IMAGE PROCESS: Sorting/trimming operations based on special shapes
128 OCR Process
130 OCR Process: Accuracy determination and matching operations on found texts
132 Communication Module: Encrypted Broadcast Message
134 Transmission Control Protocol (TCP) Server
140 POSBOX OCR Service Config File
142 OCR: Trained dataset
144 POSBOX Config Generator and Test GUI
146 Client Config File
150 POSBOX Core Client Software
152 TCP Client (internal)
154 Parse process: Meaning processes depending on order contents
156 Order Management Module
158 TCP Client (outbound)
160 Outer World
162 Beverage dispenser (e.g., Freestyle)
164 AFD/AFS machine
202 POS System
204 API
206 POS Box
220 POS Terminal
222 KDS/Display/Terminal
224 Video/HDMI/USB-C capture or interface
230 Webhook Endpoint
1501 “app” tab
1502 “tcp comm” tab
1503 sub-tabs
1504 “Select Picture TEST process” button
1505 “Quick Test Process (last selected picture)” button
1506 “Get Frame to HDMI” buttons
1701 detected objects and extracted textual content
1702 logger tab
1703 config tab
1704 log display
1801 “Get_RGB” button
1802 “Get_Header_Height” button
1803 “Get_Header_Width” button
1804 “Create_Rec_Area” button
2201 first color
2202 second color
2203 third color
2401-2403 found headers
2801 “Set_All_Configs” button
2802 “Get_Next_Camera/HDMI_ID_to_Device_Driver” button
2803 “Record_Configs” button
2804 “Read_Config” button

### DETAILED DESCRIPTION OF THE INVENTION

This invention describes a POS box that normalizes order content from a POS system and drives smart equipment. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement.

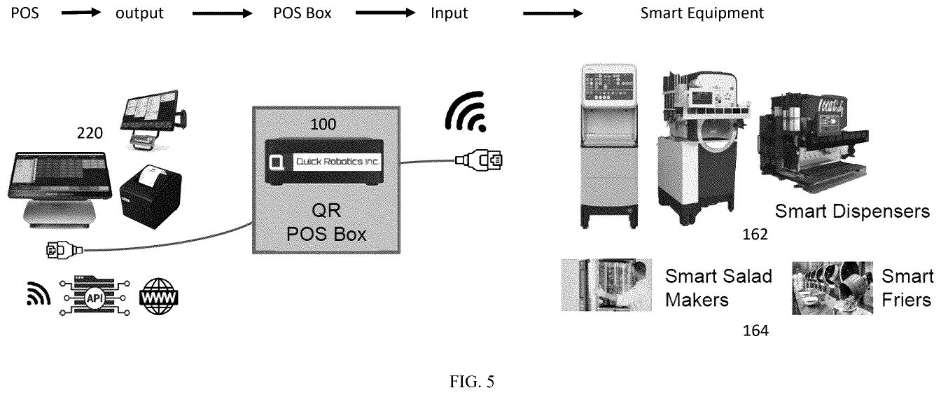

With reference to FIG. 5, a POS terminal (220) provides output to a POS Box (100). The POS BOX (100) captures and normalizes order content from the output of the POS terminal (220) and utilizes the normalized order content to control smart equipment such as a beverage dispenser (162) or a food service device (164).

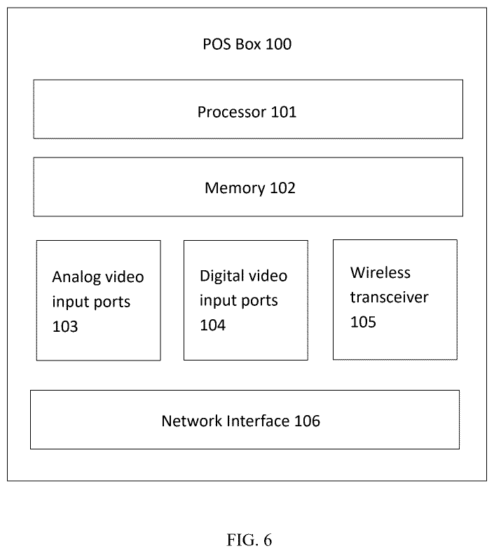

FIG. 6 is a hardware block diagram of POS Box (100) showing a processor (101), memory (102), analog video input ports (103), digital video input ports (104), a wireless transceiver (105), and a network interface (106).

The POS Box (100) is the housing and system assembly that integrates compute, memory, video ingest, and network connectivity for the bridge between heterogeneous POS systems and automated beverage equipment. In some embodiments it is an embedded appliance with a fanless enclosure, tamper-evident seals, and an internal secure element for key storage used by encrypted links to devices. The chassis may present front or rear I/O panels for serviceability, including swappable storage and accessible SIM/Wi-Fi antenna connectors. Thermal paths and heat spreaders are arranged to allow 24/7 operation in hot back-of-house environments, and an onboard watchdog resets the unit on power dips or software hangs.

Processor (101) includes one or more CPUs or SoCs that execute the capture, OCR, parsing, and orchestration workloads. Preferred implementations use multi-core 64-bit architectures with SIMD/vector instructions for image math, and optional integrated GPUs or NPUs to accelerate OCR and vision kernels. The processor runs a hardened OS with secure boot; a supervisor monitors health of services and restarts them on failure.

Memory (102) encompasses volatile and non-volatile storage used by the POS Box. Volatile memory (e.g., DDR4/DDR5) buffers high-rate frames, maintains OCR token streams, and holds execution queues, while non-volatile memory (e.g., eMMC, SSD) stores the operating system, OCR datasets and lexicons, configuration files (140, 146), logs, and audit artifacts.

Analog video input Ports (103) accept legacy video sources such as VGA, composite (CVBS), S-Video, and component (YPbPr). Each port feeds an analog-to-digital converter with anti-aliasing filters and a scaler that normalizes timing to a format expected by the capture module (122). Sync detection, clamp/blanking, and per-channel gain are auto-calibrated at boot to yield stable text edges for OCR. Hot-plug events are detected and logged, triggering safe re-lock without dropping queued orders.

Digital video input ports (104) accept HDMI, DisplayPort, MiniDP, DVI, USB-C/Alt-Mode, or SDI signals from POS/KDS devices. In one embodiment, HDCP handling or lawful mirroring is supported when required. Hardware scalers crop to the configured regions of interest to reduce bandwidth to the image pipeline (124-128). Signal integrity is preserved by short, shielded runs and equalization; loss-of-sync or mode changes raise events for the order manager (156) to pause or retry processing.

The wireless transceiver (105) provides IEEE 802.11 (e.g., 802.11ac/ax) Wi-Fi and, in some versions, Bluetooth Low Energy for device discovery and wireless screen-mirroring ingress. Multiple antennas support MIMO for stable throughput; enterprise security (WPA2-Enterprise/EAP-TLS) and certificate pinning can be enforced.

Network interface (106) supplies wired network connectivity—e.g., 10/100/1000/2.5G Ethernet via RJ-45—with support for VLAN tagging, QoS, and optionally Power-over-Ethernet to simplify installation. TLS is mandatory for device control sessions; client certificates reside in secure storage. Firewall rules restrict egress to whitelisted endpoints (e.g., beverage dispensers (162), AFS machines (164), time servers, and update services). Link state changes and DHCP or IP conflicts are reported to the operator. Redundant interfaces may be bonded for resilience, with failover policies.

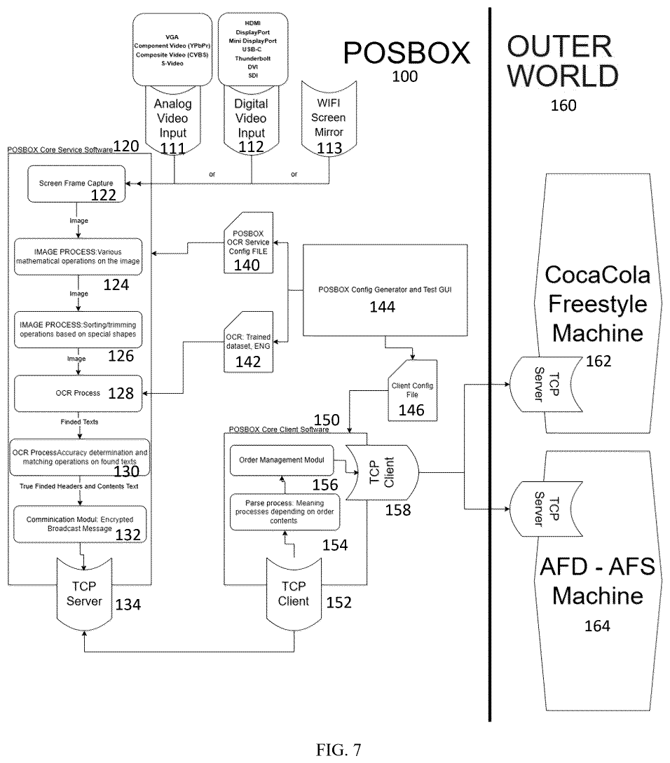

As detailed in FIG. 7, POSBOX (100) accepts display content from Analog video input (111), Digital video input (112), or Wi-Fi screen mirroring (113). Frames are processed by POSBOX Core Service Software (120) including Screen Frame Capture (122), mathematical image processing (124), shape-based sorting/trimming (126), OCR (128), and accuracy/matching (130). Qualified results are serialized by a communication module (132) and published on an internal TCP server (134). A Core Client (150) subscribes via TCP client (152), performs parse/semantics (154) to a canonical recipe, and manages execution through an order management module (156). Device-specific commands are issued through an outbound TCP client (158) to external machine servers in the outer world (160), including smart beverage machine (162) and AFD/AFS devices (164). Configuration is maintained in an OCR service config file (140) and a client config file (146) produced and tested with a config generator and test GUI (144); OCR uses a trained dataset (142).

To be more specific, the POSBOX (100) is a computing appliance that bridges heterogeneous point-of-sale (POS) displays and automated beverage equipment. It comprises one or more processors, volatile and non-volatile memory, video capture hardware (or network mirroring), and network I/O. Its firmware boots a minimal OS and launches the Core Service Software (120) and Core Client Software (150). The chassis may expose HDMI/DVI/USB-C or analog capture inputs, Ethernet/Wi-Fi for LAN access, and a secure storage partition for configuration files (140, 146) and logs. In some embodiments, (100) is fanless and tamper-evident; an onboard secure element stores encryption keys used by the internal broadcast (132) and device sessions.

Analog Video Input (111) is an analog video stream received from legacy POS/KDS hardware via VGA, component (YPbPr), composite (CVBS), or S-Video through the Analog video input port (103). A scaler converts the incoming timing (e.g., 480i-1080p) to a normalized buffer for the capture module (122). The signal chain may include per-channel gain, sync reconstruction, and gamma/white-balance correction to stabilize text edges before image processing.

Digital Video Input (112) is a digital stream received from digital video input ports (104) such as HDMI, DisplayPort, MiniDP, USB-C/Alt Mode, Thunderbolt, DVI, or SDI. An HDCP-compliant capture path or screen-mirror workaround may be used where lawful. The module can sub-sample or crop to regions of interest to reduce bandwidth to the processing pipeline. Hot-plug events trigger dynamic re-locking and configuration reloads to avoid OCR resets mid-order.

Wi-Fi Screen Mirror (113) is a wireless display stream received from POS/KDS devices via Miracast/AirPlay/Chromecast-style protocols or vendor SDKs via the wireless transceiver (105). A jitter buffer compensates for variable network latency and packet loss. The mirror path can fall back to periodic JPEG snapshots when continuous streaming is unavailable.

POSBOX Core Service Software (120) orchestrates frame ingestion, pre-processing, OCR, and publication of structured results. The POSBOX Core Service Software (120) is stored within the memory (102) configured to be executed by the processor (101). Each stage (122-132) publishes metrics (latency, confidence histograms) used to tune thresholds in the config file (140).

Screen Frame Capture (122) acquires frames from the active input path, detects display changes (e.g., via histogram deltas), and captures at an adaptive cadence to minimize redundant OCR. It supports de-interlacing and frame de-duplication. A capture window can be applied to ignore toolbars or clock areas. The frame is tagged with source ID, resolution, and color space for downstream operators. A ring buffer retains N recent frames for audit and re-OCR if parsing fails.

IMAGE PROCESS—Various mathematical operations (124) performs pixel-domain transforms to stabilize text: character similarity calculation (e.g., Levenshtein Distance), histogram equalization, edge detection (e.g., Sobel/Canny), noise filtering using mean/standard deviation, and contour area calculation. Parameters are configurable per site (140) and may auto-tune based on live quality metrics. The output is a canonical, OCR-ready image region with bit-depth and DPI suitable for the engine (128).

IMAGE PROCESS—Sorting/trimming based on special shapes (126) segments the processed frame into regions of interest (ROIs) by detecting geometric primitives (rectangles, ruled lines, table grids) and dense text bands. Special shapes refer to visual regions such as rectangular labels, price boxes, or barcode frames that are to be recognized by OCR. The coordinates of these shapes are sorted according to predefined rules (e.g., largest area, top-left to bottom-right order). Trimming refers to removing data outside these regions from the image. Example: If OCR detects a price tag, only that region is cropped and sent to the OCR engine. The sorting/trimming process separates header vs. body zones and trims margins to reduce false positives. The system can operate template-free (connected components, projection profiles) or template-guided using masks defined during calibration in the GUI (144). Detected ROIs are ordered logically (top-to-bottom, left-to-right) and passed to OCR with coordinates for later mapping.

OCR Process (128) converts ROIs into text tokens with bounding boxes and per-character/word confidence. It may use a CPU-or GPU-accelerated recognizer seeded by the trained dataset (142). Language hints (English primary, vendor-specific symbols) improve segmentation and ligature handling. The engine returns token streams grouped by line.

OCR Process—Accuracy determination and matching (130) merges wrapped tokens, resolves near-matches using edit distance and phonetic keys, and validates field structure (e.g., item+modifiers). Confidence is computed at token, line, and ticket levels; fields below threshold are flagged for confirmation or excluded from automation. The module applies synonym maps and catalog lookups to canonicalize items (e.g., “VAN”→“Vanilla”) and interprets quantities (“2×”, “double”). A final, qualified order object is generated with provenance (ROI coords, confidences) to enable traceable audits.

OCR accuracy is calculated by comparing the OCR output with “ground truth” data, measured as Character Accuracy Rate (CAR). Matching operation compares OCR outputs with product data in a database. For example, a OCR result of “Coca Cola 1 L” will have a closest match in database of “Coca Cola 1 L” (92% match). The OCR process uses a predefined threshold (e.g., 85%) that a match is accepted.

Communication Module-Encrypted Broadcast Message (132) serializes qualified orders into a schema containing identifiers, timestamps, header/body arrays, and totals, and encrypts payloads for integrity and confidentiality. Messages are published over a localhost or LAN endpoint for consumption by clients (150). Rate-limiting, retry queues, and message deduplication prevent flooding and replay. The module supports versioned schemas so clients can roll independently from OCR services.

TCP Server (134) is an internal server (134) that exposes the encrypted feed as a TCP (or TLS) socket to local subscribers. It manages client sessions, heartbeats, and back-pressure; slow consumers are isolated to avoid blocking the pipeline. Mutual authentication (client certificates) can be enforced. The server logs connection metadata and high-water marks for capacity planning. In some embodiments, (134) supports UDP multicast for discovery with TCP/TLS for payloads.

POSBOX OCR Service Config File (140) is a signed JSON/YAML document that defines input sources, ROIs, thresholds, lexicons, and security parameters. It may include a text_area_matrix, process windows, edge thresholds, and per-store overrides. Checksums prevent tampering. The core service software (120) hot-reloads the config file (140) with validation and rollback on error. Version history links each config to performance metrics for continuous improvement.

The OCR service configuration file (140) (e.g., ‘ocr_config.json’) contains the following service_config:

{
“canny_thresold_1”: 50,
“canny_thresold_2”: 150,
“gaussian_blur_sigma_x”: 0,
“color_filter_thresold”: 50,
“color_filter_direction”: 1,
“color_r”: 0,
“color_g”: 0,
“color_b”: 0,
“contour_edge_tolerans”: 0.04,
“finded_rect_min_width”: 230,
“finded_rect_max_width”: 450,
“finded_rect_min_height”: 160,
“finded_rect_max_height”: 1200,
“rectangle_mode_select”: 3,
“header_width”: 263,
“header_height”: 55,
“text_area_matrix_width”: 10,
“text_area_matrix_height”: 15,
“process_time_ms”: 6000,
“tcp_server_port”: 50088,
“hdmi_port”: 1,
“hdmi_converter_hardware_id”: “USB\\VID_0FD9&PID_00A1&REV_0000”,
“text_area_matrix”: [
[1,1,1,1,1,1,1,1,1,1],
[1,1,1,1,1,1,1,3,1,1],
[1,1,1,1,1,1,1,1,1,1],
[1,1,1,1,1,1,1,1,1,1],
[1,1,1,1,1,1,1,1,1,1],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2],
[2,2,2,2,2,2,2,2,2,2]
]
}

The service_config profile is the backbone of the core image processing engine. It defines all critical mathematical constants, tolerances, filter thresholds, and detection algorithms. Furthermore, it includes physical device parameters specific to the host PC or hardware platform such as HDMI port selection, hardware identifiers, timing parameters, and rectangle detection tolerances.

This configuration governs the logic for identifying “order rectangles” within the visual field. Parameters such as Canny edge detection thresholds, Gaussian blur radius, color filter vectors, and text area mapping matrices are defined here. These allow precise and adaptive fine-tuning of the computer vision process, making the system adaptable to various screen types, lighting conditions, and content styles.

This configuration determines which areas the OCR will work on, which language it will use, and how the results will be post-processed.

In one embodiment, the POSBOX OCR Service Config File (140) includes a squareup_config for API and External Service Integration. The squareup_config module handles API-level integration and external service communication, particularly for platforms such as Square POS. It allows the processed order data to be transmitted, synchronized, and managed via structured REST or TCP-based communication channels.

This module enables dynamic mapping between identified visual elements and logical order fields such as:
Red Regions: Correspond to Order ID.
Blue Regions: Correspond to Order Content.
Green Regions: Correspond to the Order Color.

These color-coded pixel segments are extracted from the live or static visual feed, enabling robust and efficient classification of order information directly from the screen. An example of the squareup_config is shown below:

{
“application_id”: “sq0idp-E0Ua8d7GQwp8WggETsksbkA”,
“access_token”: “EAAAltysfXfw9hHy5v54TagQ7MqmXLcSZxY_zO-
kbktgUoAsChEdQdUf1qfohFETB”,
“post_orders_api_url”: “https://connect.squareup.com/v2/orders/search”,
“location_ids”: [
“LS0GVXERNH0VN”
],
“square_version”: “2024-11-20”,
“retry_attempts”: 3,
“proxy”: {
“enabled”: false,
“host”: “proxy.example.com”,
“port”: 8080,
“username”: “proxy_user”,
“password”: “proxy_password”
}
}

OCR—Trained dataset, ENG (142) supplies recognition models and language data for the OCR engine, tuned for POS/KDS fonts and artifacts (bold, inverse video, narrow columns). The OCR trained dataset is retrained on a base open-source model (e.g., Tesseract OCR) using a custom POS screen dataset. This process includes collecting over 5000 POS screen images, labeling data (e.g., price, barcode, category) using tools like LabelImg, and applying transfer learning to retrain the model. The training is completed using a TensorFlow-based OCR training pipeline. Updates are signed and delivered via a secure channel; the OCR process (128) verifies compatibility of the trained dataset (142) before loading the trained dataset (142).

POSBOX Config Generator and Test GUI (144) is a calibration and validation tool that lets an operator live-view captures, draw ROIs, label fields (headers, items), run test orders, and export configs (140, 146). It supports offline image simulation and live HDMI capture to tune parameters. The GUI visualizes OCR results, confidences, and parser outputs, and highlights low-confidence regions for adjustment. Role-based access controls limit configuration changes to authorized users.

The configuration generator and test GUI (144) includes the following screens:
Setup Screen: For network setup and device registration
Login Screen: Username/password access
Management Panel: OCR settings, software updates, log monitoring

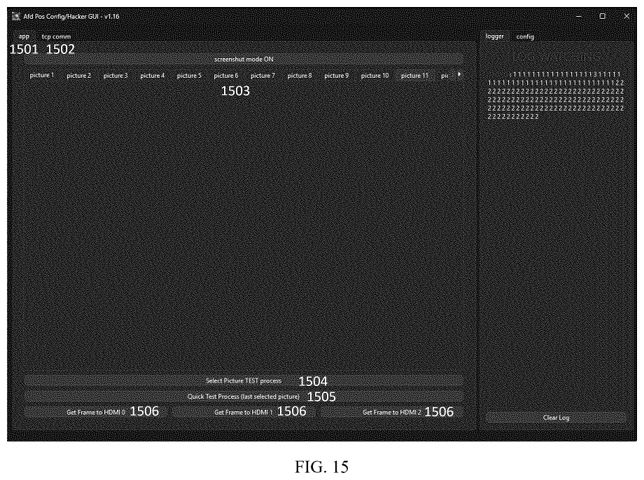

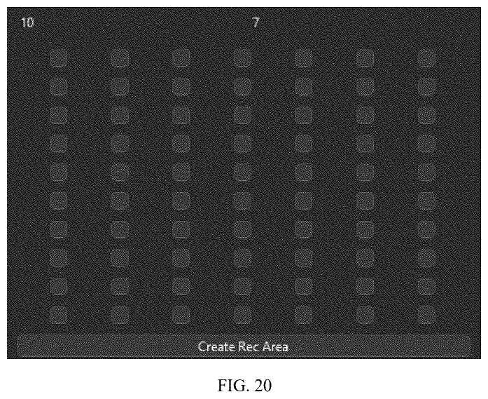

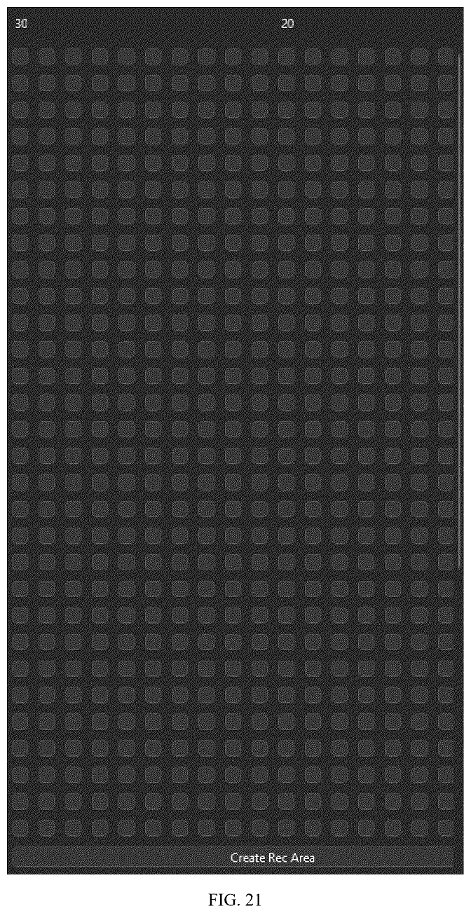

The configuration generator and test GUI are controlled by technical staff (e.g., product manager or integration engineer). As shown in FIGS. 15-23, the config generator can be configured to generates a JSON-based configuration file based on screen resolution, OCR areas, and system parameters, and the test GUI simulates how the config file works in the field. Users can upload screenshots and instantly test OCR results. The configuration generator and test GUI provides a visual configuration interface, which serves both configuration and simulation purposes:
Offline Testing: Users may load static test images directly from the local PC to fine-tune all image processing parameters.
Real-Time Simulation: The GUI can access HDMI ports or camera devices connected to the PC, allowing real-time image acquisition from external devices (e.g., an HDMI output device, a camera, or a live display screen).
The configuration generator and test GUI (144) enables a seamless end-to-end simulation of the actual deployment environment—validating detection logic under real conditions without requiring the entire production system to be active.

To be more specific, FIG. 15 illustrates a landing page including an “app” tab 1501 and a “tcp comm” tab 1502. Sub-tabs 1503 (i.e. picture tabs) are control buttons configured to periodically capture the display output, thereby initiating image processing and Optical Character Recognition (OCR) algorithms.

The “Select Picture TEST process” button 1504 allows a user to load a PNG image from a user-selected file and activates the image processing and OCR algorithms, the “Quick Test Process (last selected picture)” button 1505 allows a user to reload the most recently added image for quick reprocessing, and the “Get Frame to HDMI” buttons 1506 allow the user to capture display frames directly from the HDMI ports of the target PC.

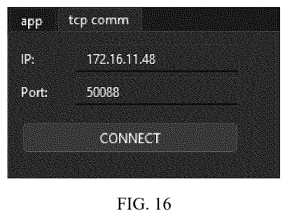

FIG. 16 illustrates the TCP connection setting including an IP address field and a port field for setting up a communication with the outside world and test option.

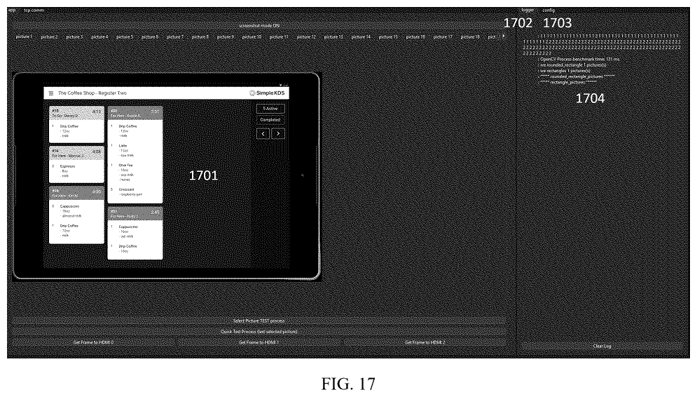

FIG. 17 illustrates detected objects and any extracted textual content 1701 being output to the log display 1704 in the logger tab 1702 with the corresponding predefined format.

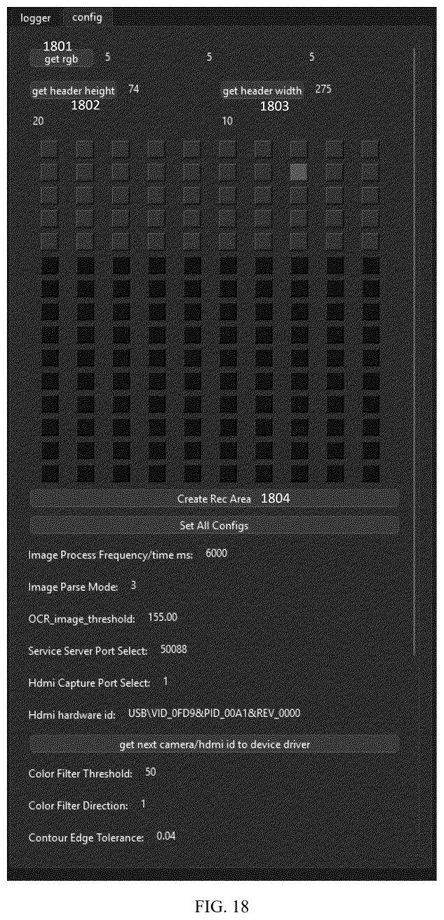

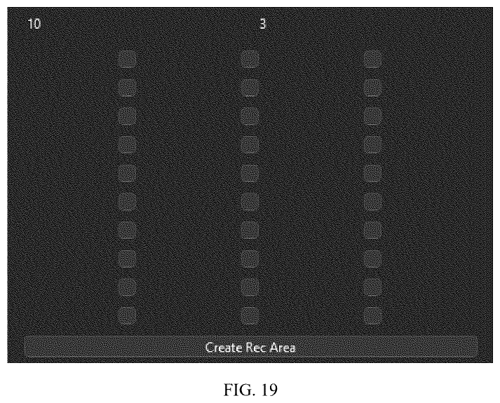

Once the config tab 1703 is clicked, the config tab screen as shown in FIG. 18 is displayed. The “Get_RGB” button 1801 allows the user to select a pixel from the currently loaded image to determine and store the background color for filtering purposes. The “Get_Header_Height” button 1802 and the “Get_Header_Width” button 1803 allow the user to define and store the pixel dimensions of the header area by selecting them directly from the image. The designated order header and content regions are aligned into an OCR input matrix. The matrix dimensions are configurable (e.g., currently set to 20×10) via the text boxes above, and are generated using the “Create_Rec_Area” button 1804. FIGS. 19-21 show examples of other matrix dimensions set, e.g. 10×3, 10×7, and 30×20, respectively. Matrix dimensions can be adjusted to improve OCR and image processing accuracy. Background adjustments are applied by clicking on specific matrix pixels.

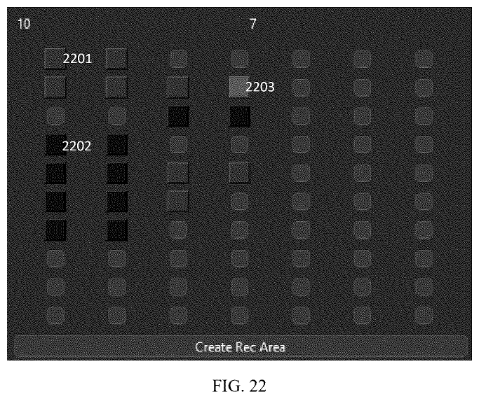

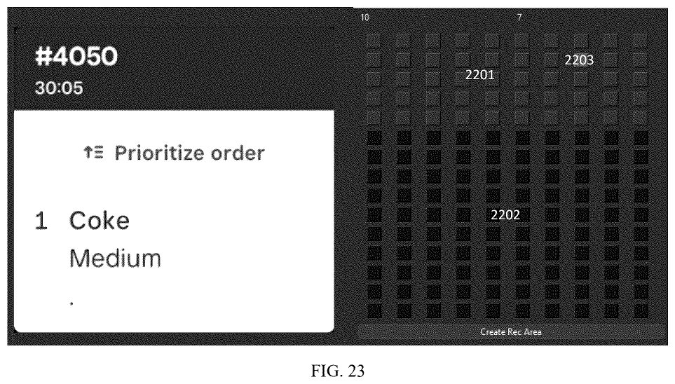

Matrix dimensions can be adjusted to improve OCR and image processing accuracy. Background adjustments are applied by clicking on specific matrix pixels. FIGS. 22-23 show that a first color 2201 indicates the header section to be parsed, a second color 2202 indicates the content section to be parsed, and a third color 2203 indicates the pixel used to detect and extract the order background color (must be a single pixel). Users can customize configurations freely. In one embodiment, a fourth color can be used to mark an area to be excluded from image processing and OCR operations.

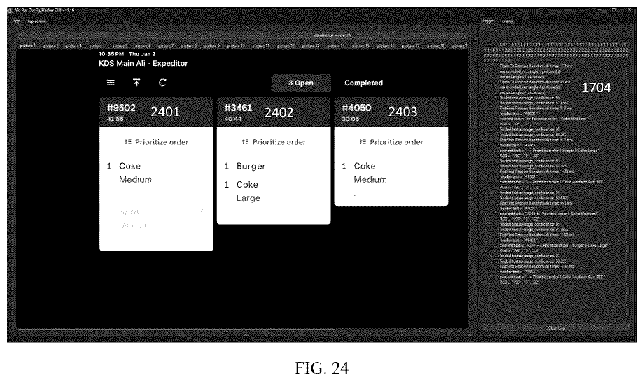

FIG. 24 shows all OCR and image processing stages can be monitored step-by-step from the Pictures tab. During the image processing phase, multiple algorithms are employed for edge filtering and rectangular shape detection. This visualization is critical, allowing the developer to observe filter outputs for edge detection, OCR preprocessing, and all other applied transformations. In the example, the found headers 2401, 2402, and 2403 and their associated contents are written in the LOG window 1704.

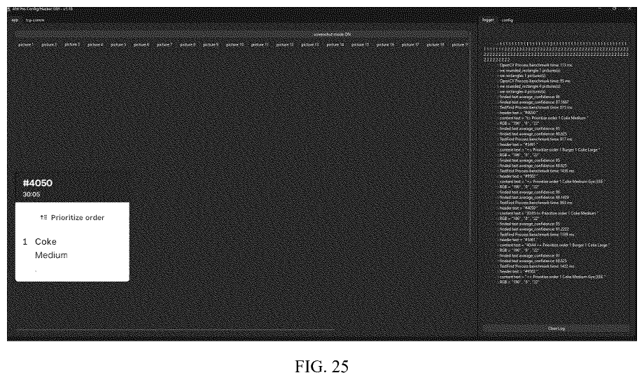

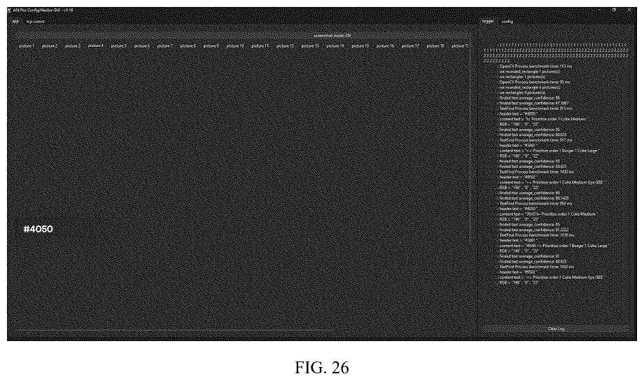

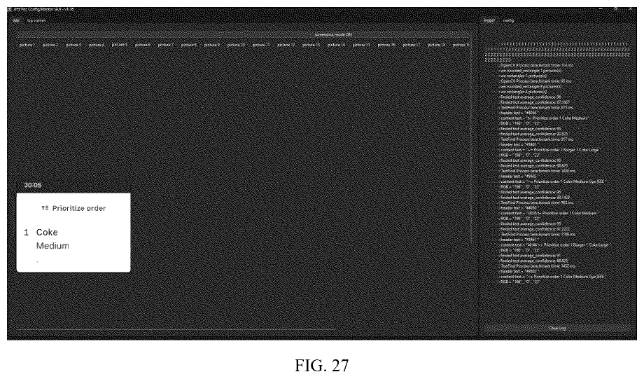

FIG. 25 shows an example of an order captured. FIG. 26 illustrates that the header is detected and is separated displayed to the user, and FIG. 27 illustrates that the content is detected and is separated displayed to the user.

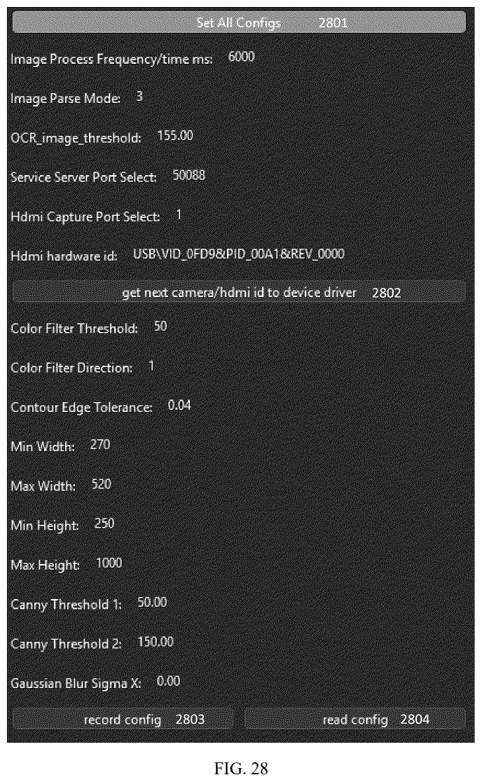

FIG. 28 illustrates control parameters for image processing, OCR, and hardware configuration. The “Set_All_Configs” button 2801 allows the user to apply current modifications directly in runtime without saving them, for testing purposes, the “Record_Configs” button 2803 allows the user to save the current settings as the final configuration to be used by the production service software, the “Read_Config” button 2804 allows the user to load previously stored configurations, and the “Get_Next_Camera/HDMI_ID_to_Device_Driver” button 2802 identifies the hardware name of the HDMI-to-USB converter connected to the PC and registers it with the software, ensuring the service software recognizes the device, handles automatic reconnection, and prevents operation with unauthorized hardware. This enhances both security and operational robustness.

By combining configuration, simulation, and live testing within a single GUI, developers and system integrators can rapidly iterate and deploy reliable, high-performance visual recognition systems for order processing.

Client Config File (146) defines client-side parsing, device mapping, and orchestration preferences used by the Core Client (150). The client config file encapsulates all networking and communication settings required to establish and maintain data transmission between the local processing unit and any external servers or clients. Additionally, this layer is responsible for parsing and interpreting the results produced by the image processing engine. In essence, it manages the front-end to back-end communication and the extraction of actionable metadata from the processed visual content. An example of a client config file is shown below:

POSBOX Core Client Software (150) consumes the encrypted broadcast (132) via (152), applies parsing (154), manages the order lifecycle (156), and communicates with devices via outbound sessions (158). In one embodiment, the client can operate on the same host as the core service software (120) or on a separate host subscribing over the LAN.

TCP Client (internal subscription) (152) establishes and maintains a secure session to the internal server (134). It validates server identity, subscribes to the broadcast stream, and acknowledges receipt to support exactly-once or at-least-once semantics. The client exposes metrics (latency, backlog) to the order manager (156) for dynamic throttling.

Parse process—Meaning processes depending on order contents (154) converts qualified text into a canonical recipe: beverage type, size, ingredient list with amounts/units, options (ice, sweetness, temperature), and procedural steps. It resolves synonyms, applies size-based scaling factors, and interprets modifiers (“2× Vanilla,” “No Ice,” “Light Sweetness”). Grammar rules and optional ML models disambiguate ambiguous tokens. The output is validated against device capability profiles before orchestration.

Order Management Module (156) deduplicates orders using signatures (order ID+time+total), prioritizes queues (e.g., rush), and tracks states (RECEIVED→PARSED→DISPATCHED→ACKED→DONE/ERROR). It handles retries on NAK/timeouts, manages remakes, and supports partial fulfillment across multiple devices.

TCP Client (outbound to external machines) (158) opens secure sessions to device servers, negotiates protocol versions, and sends device-specific commands. It implements heartbeat/keep-alive, command sequencing, and ACK/NAK handling. Rate limits prevent overrun; idempotent re-issue protects against duplicated pours. If a device lacks a requested capability, (158) informs (156) to select alternatives or down-convert the recipe with operator notice.

OUTER WORLD (160) denotes the external equipment environment reachable from POSBOX (100). It may comprise multiple network segments, VLANs, or fieldbuses connecting dispensers, mixers, or ancillary sensors. Network policy can restrict egress from (100) to whitelisted device IPs/ports. Device discovery may be static (configured endpoints) or dynamic (broadcast/mDNS) depending on site policy.

Smart Beverage Machine (162) represents a beverage dispenser exposing a TCP-accessible control interface. A driver translates canonical recipes into selections, size, ice dispense, flavor shots, and pour commands with acknowledgments and error codes. The driver performs capability discovery on connect and adjusts command sets per firmware/version. Safety interlocks (e.g., door open, low syrup) are surfaced to the operator. Logs link each pour to its originating order for traceability. In one embodiment, the smart beverage machine (162) is a Coca-Cola Freestyle® machine.

AFD/AFS Machine (164) represents an automated food system exposing a network protocol for food preparation, including dosing, temperature control, agitation, and timing. The driver maps recipe steps to valve actuations, pump rates, or thermal setpoints, and monitors telemetry for completion or faults. Where multi-device workflows are required, the AFD/AFS Machine (164) participates in orchestrated sequences coordinated by (156). Unsupported options trigger recipe down-conversion or alternate device routing.

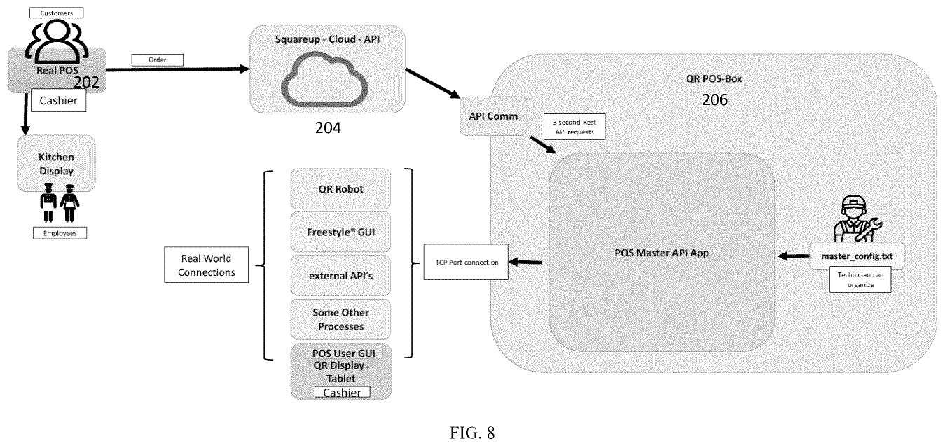

FIGS. 8-10 illustrates different ways for the POS box of the instant disclosure to integrate with an existing POS system: API, Webhook, and KDS/display capture.

FIG. 8 illustrates the API mode that a POS system (202) exposes an API (204) polled by POSBOX (206) at a configurable cadence; retrieved orders are normalized and scheduled as described for parsing (154) and order management (156).

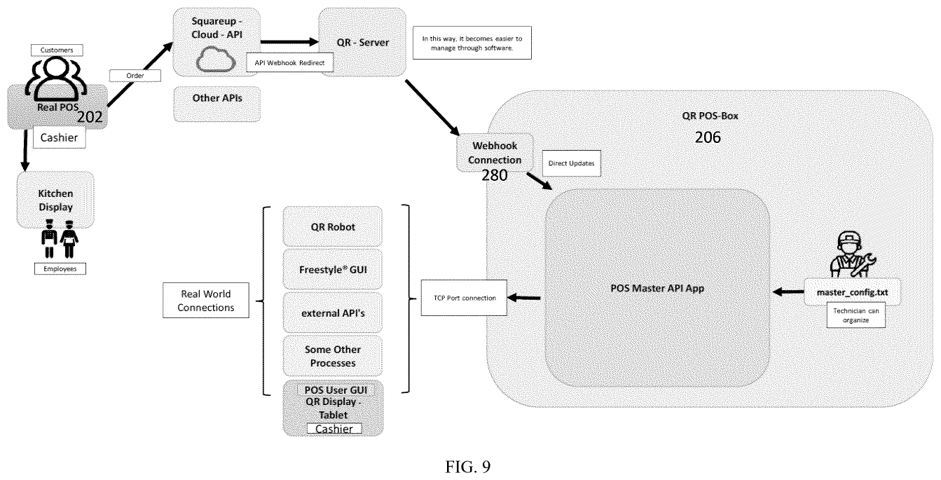

FIG. 9 illustrates a webhook mode that the POS system (202) pushes order events to a webhook endpoint (230) reachable by the POSBOX (206). Webhook payloads are parsed into the same canonical structures used by OCR-derived orders.

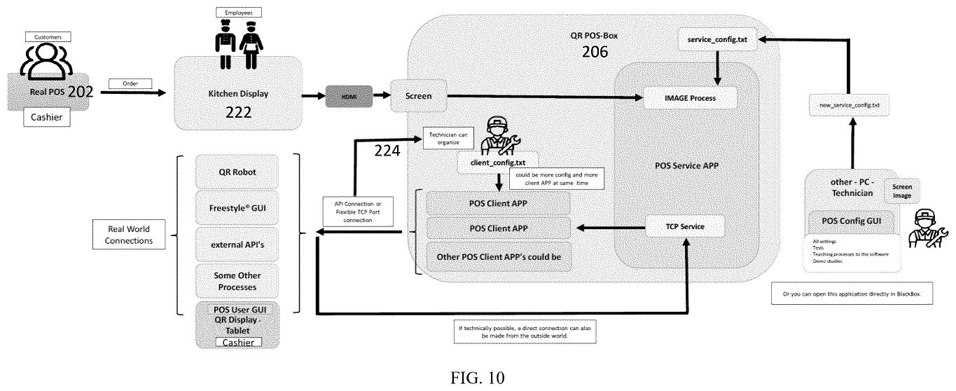

FIG. 10 illustrates the KDS/display capture mode that a KDS/display (222) outputs a video signal through HDMI/capture (224) into POSBOX (206), which executes the image/OCR pipeline (124, 126, 128, 130) to extract headers and line-item content.

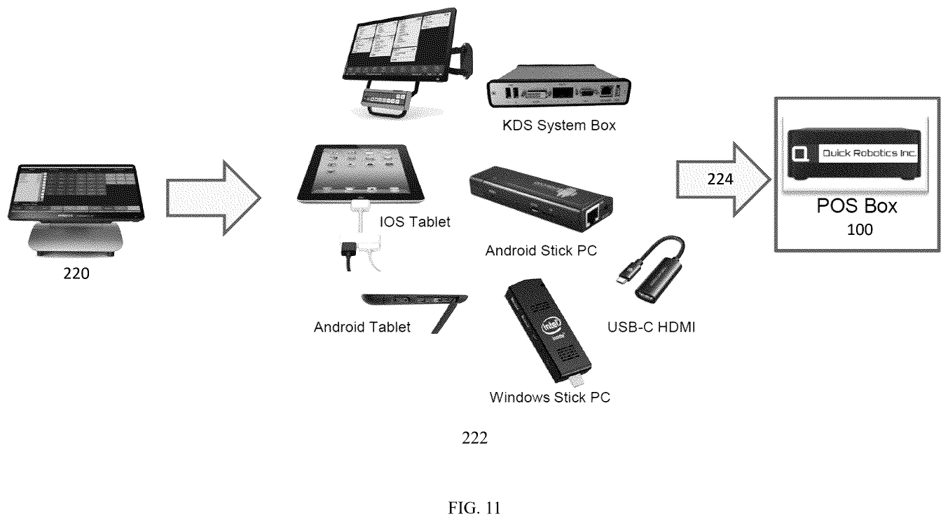

FIGS. 11-14 further illustrates exemplary implementations of the POS box (100) with existing POS systems.

FIG. 11 illustrates representative device inputs. As shown in FIG. 11, a POS terminal (220) and at least one of a POS display device or a KDS system box (222) is connected to the POS Box (100) for video/image capture (224).

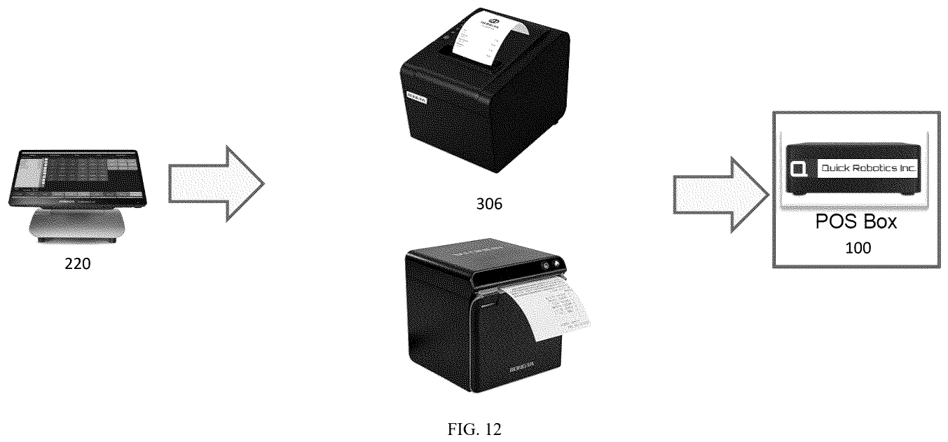

In another embodiment, FIG. 12 shows a POS terminal (220) generates output through printers (306); the POS Box (100) renders the printer data to a virtual canvas for OCR (128), enabling automation even when APIs or direct video feeds are unavailable.

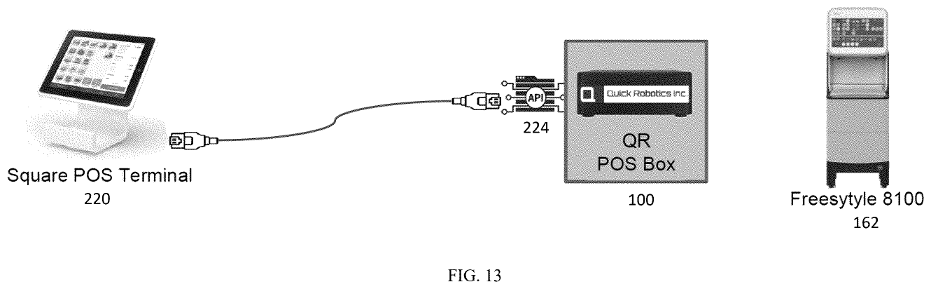

In FIG. 13, a POS terminal (220) connects via an interface (224) to the POS Box (100), which commands a Freestyle dispenser (162) to prepare beverages according to the normalized recipe.

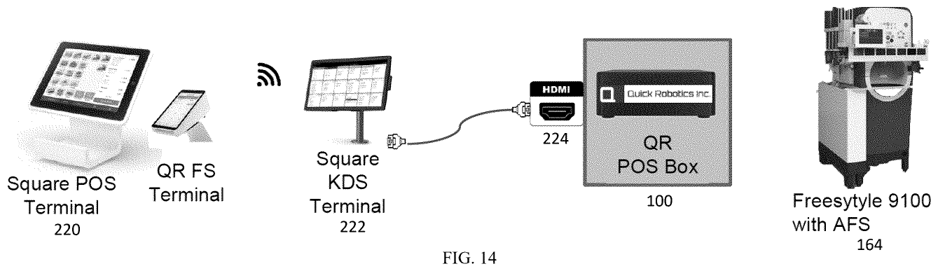

In FIG. 14, a deployment with a POS terminal (220) and KDS terminal (222) feeds HDMI (224) into the POS Box (100), which controls an AFS-class machine (164); the same orchestration pipeline applies.

The foregoing description, figures, reference numerals, examples, and feature groupings illustrate representative embodiments of the disclosed POS-to-device bridge and are not intended to limit the invention. Functions attributed to particular blocks (e.g., capture (111/112/113/122/224), recognition (124-130), messaging (132/134), client parsing and orchestration (150-158)) may be combined, separated, reordered, executed in parallel or distributed across one or more physical or virtual machines, and implemented in hardware, firmware, software, or any combination thereof. The system is equally applicable to non-beverage preparation equipment and to alternative data sources (e.g., cameras, virtual displays, printer streams) and transports (wired or wireless, synchronous or asynchronous). Data formats, protocols, machine-learning models, and security mechanisms may be substituted with equivalents without departing from the inventive concepts. As used herein, “comprise,” “include,” and “have” are open and non-exclusive; “or” is inclusive; “based on” means “based at least in part on”; and “first/second,” etc., denote labels and not order or priority. Instructions described herein may be stored on non-transitory computer-readable media and executed by one or more processors. The scope of the invention is defined only by the claims and their legal equivalents.

What is claimed is:

1. A system comprising:
a processor;
a memory;
a capture interface configured to receive image data representing rendered display output of a point-of-sale (POS) system of an unknown vendor, wherein the capture interface receives the image data without invoking an application programming interface of the POS system;
an internal Transmission Control Protocol (TCP) server;
a core service software stack stored in the memory and configured to be executed by the processor, and causes the processor to pre-process the image data, performing a shape-based sorting and trimming on the image data, performing an optical character recognition using a trained dataset, verifying and qualifying OCR results by analyzing a matching accuracy, and generating an encrypted broadcast message and exposing the message via the internal TCP server;
a parser configured to transform qualified text into a canonical beverage recipe; and
a TCP client configured to transmit device-specific commands to at least one external beverage machine.

2. The system of claim 1, wherein the capture interface comprises an analog video input port, a digital video input port, and a wireless transceiver.

3. The system of claim 1, wherein the capture interface comprises at least one of HDMI, DVI, VGA, and USB-C connection from a kitchen display system.

4. The system of claim 1, wherein the core service software stack further causes the processor to detect geometric shapes to crop regions corresponding to headers, line items, modifiers, and totals.

5. The system of claim 1, further comprises an order management module software stored in the memory and configured to be executed by the processor to queue, deduplicate, and track preparation states.

6. The system of claim 4, wherein the parser maps synonyms and size-based scaling to a canonical recipe model and the order management module deduplicates orders using a signature comprising an order identifier and a timestamp.

7. The system of claim 1, further comprising a graphic user interface (GUI) configured to create an OCR service config file and a client config file.

8. The system of claim 7, wherein the OCR service config file defines mathematical constants, tolerances, filter thresholds, detection algorithms, physical device parameters specific to a host PC or hardware platform, hardware identifiers, timing parameters, and shape detection tolerances.

9. The system of claim 7, wherein the client config file defines client-side parsing, device mapping, and orchestration preferences.

10. A computer-implemented method comprising:
receiving, via a capture interface, image data representing rendered POS display output without a point-of-sale (POS) application programming interface (API) integration;
performing image pre-processing and shape-based sorting and trimming on the image data;
performing an optical character recognition (OCR) on the image data using a trained dataset to obtain order text;
determining accuracy and matching operations on the order text;
broadcasting an encrypted message on an internal TCP server;
consuming the message via a TCP client;
parsing meaning depending on order contents into a canonical recipe; and
transmitting device-specific commands to an external beverage machine.

11. The method of claim 10, further comprises storing the received image data, recognized text with confidences, parsed canonical order, device commands, and acknowledgements with an order identifier.

12. The method of claim 10, wherein the capture interface comprises an analog video input port, a digital video input port, and a wireless transceiver.

13. The method of claim 10, wherein the capture interface comprises at least one of HDMI, DVI, VGA, and USB-C connection from a kitchen display system.

14. The method of claim 10, further comprises detecting geometric shapes to crop regions corresponding to headers, line items, modifiers, and totals.

15. The method of claim 10, further comprises queueing, deduplicating, and tracking preparation states.

16. The method of claim 15, further comprises mapping synonyms and size-based scaling to a canonical recipe model and deduplicating orders using a signature comprising an order identifier and a timestamp.

17. The method of claim 10, further comprises creating, by a graphic user interface (GUI), an OCR service config file and a client config file.

18. The method of claim 17, wherein the OCR service config file defines mathematical constants, tolerances, filter thresholds, detection algorithms, physical device parameters specific to a host PC or hardware platform, hardware identifiers, timing parameters, and shape detection tolerances.

19. The method of claim 17, wherein the client config file defines client-side parsing, device mapping, and orchestration preferences.

20. A non-transitory computer-readable medium storing instructions that, when executed by one or more processors, cause the processors to perform the method of claim 10.
